(19) United States
(12) Patent Application Publication
(10) Pub. No.: US 2025/0271589 A1
(43) Pub. Date: Aug. 28, 2025

(54) Modeling of Geological Storage Projects

(71) Applicant: Chevron U.S.A. Inc., San Ramon, CA (US)

(72) Inventors: Yousef GHOMIAN, Houston, TX (US); Matthew Hamilton BENNETT, Houston, TX (US); Nicholas Christopher SKRIVANOS, Bakersfield, CA (US); Iryna Petrovska MARCHIANO, Houston, TX (US); Andrew Kenneth HAYNES, Perth (AU)

(21) Appl. No.: 18/927,725

(22) Filed: Oct. 25, 2024

Related U.S. Application Data
(60) Provisional application No. 63/558,595, filed on Feb. 27, 2024.
(60) Provisional application No. 63/558,598, filed on Feb. 27, 2024.
(60) Provisional application No. 63/691,801, filed on Sep. 6, 2024.

(51) Int. Cl. G01V 20/00

(52) U.S. Cl. CPC G01V 20/00

(57) ABSTRACT

A method is described of modifying pore volume and transmissibility in a numerical grid. The method may be executed by a computer system. The method may include for each extension, determining a pore volume multiplier for each edge band using the determined edge band volume for that edge band and the determined pore volume for that edge band; for each extension, determining a transmissibility multiplier for each edge band using the determined pore volume multiplier for that edge band and the determined pore volume multiplier for an adjacent edge band; and modifying pore volume and transmissibility of each edge band in the numerical grid using the determined pore volume multiplier and the determined transmissibility multiplier.

### CROSS-REFERENCE TO RELATED APPLICATIONS

This application claims priority to U.S. Provisional Application Ser. No. 63/558,595, filed on Feb. 27, 2024, the contents of which is hereby incorporated by reference in its entirety. This application claims priority to U.S. Provisional Application Ser. No. 63/558,598, filed on Feb. 27, 2024, the contents of which is hereby incorporated by reference in its entirety. This application claims priority to U.S. Provisional Application Ser. No. 63/691,801, filed on Sep. 6, 2024, the contents of which is hereby incorporated by reference in its entirety.

### STATEMENT REGARDING FEDERALLY SPONSORED RESEARCH OR DEVELOPMENT

Not applicable.

### TECHNICAL FIELD

The disclosed embodiments relate generally to techniques for modifying pore volume and transmissibility in a numerical grid.

### BACKGROUND

There is significant interest in modeling geological storage projects, such as modeling carbon (CO₂) storage. While various methods have been explored, existing methods for modeling CO₂ storage may exhibit shortcomings. Accordingly, there remains a need for new methods for modeling CO₂ storage. The methods disclosed herein address these and other needs.

### SUMMARY

In accordance with some embodiments, a method of modifying pore volume and transmissibility in a numerical grid is disclosed. In one embodiment, the method includes a) obtaining a numerical grid for an area of interest (AOI) in a formation, wherein the numerical grid comprises edge bands, wherein the edge bands act as proxies to extensions of the formation, and wherein each extension has a corresponding total pore volume; b) for each extension, determining an edge band volume for each edge band; c) for each extension, determining a ratio using the total pore volume and a sum of the determined edge band volumes; d) for each extension, determining a pore volume to be added to each edge band responsive to the determined ratio; c) for each extension, determining a pore volume multiplier for each edge band using the determined edge band volume for that edge band and the determined pore volume for that edge band; f) for each extension, determining a transmissibility multiplier for each edge band using the determined porc volume multiplier for that edge band and the determined pore volume multiplier for an adjacent edge band; and g) modifying pore volume and transmissibility of each edge band in the numerical grid using the determined pore volume multiplier and the determined transmissibility multiplier.

In yet another aspect of the present invention, to address the aforementioned problems, some embodiments provide a computer system. The computer system includes one or more processors, memory, and one or more programs. The one or more programs are stored in memory and configured to be executed by the one or more processors. The one or more programs include an operating system and instructions that when executed by the one or more processors cause the computer system to perform any of the methods provided herein. The system may perform a method. In one embodiment, the method includes a) obtaining a numerical grid for an area of interest (AOI) in a formation, wherein the numerical grid comprises edge bands, wherein the edge bands act as proxies to extensions of the formation, and wherein each extension has a corresponding total pore volume; b) for each extension, determining an edge band volume for each edge band; c) for each extension, determining a ratio using the total pore volume and a sum of the determined edge band volumes; d) for each extension, determining a pore volume to be added to each edge band responsive to the determined ratio; c) for each extension, determining a pore volume multiplier for each edge band using the determined edge band volume for that edge band and the determined porc volume for that edge band; f) for each extension, determining a transmissibility multiplier for each edge band using the determined pore volume multiplier for that edge band and the determined pore volume multiplier for an adjacent edge band; and g) modifying pore volume and transmissibility of each edge band in the numerical grid using the determined porc volume multiplier and the determined transmissibility multiplier.

In another aspect of the present invention, to address the aforementioned problems, some embodiments provide a non-transitory computer readable storage medium storing one or more programs. The one or more programs comprise instructions, which when executed by a computer system with one or more processors and memory, cause the computer system to perform any of the methods provided herein. In one embodiment, the method includes a) obtaining a numerical grid for an area of interest (AOI) in a formation, wherein the numerical grid comprises edge bands, wherein the edge bands act as proxies to extensions of the formation, and wherein each extension has a corresponding total pore volume; b) for each extension, determining an edge band volume for each edge band; c) for each extension, determining a ratio using the total pore volume and a sum of the determined edge band volumes; d) for each extension, determining a pore volume to be added to each edge band responsive to the determined ratio; e) for each extension, determining a pore volume multiplier for each edge band using the determined edge band volume for that edge band and the determined pore volume for that edge band; f) for each extension, determining a transmissibility multiplier for each edge band using the determined pore volume multiplier for that edge band and the determined pore volume multiplier for an adjacent edge band; and g) modifying pore volume and transmissibility of each edge band in the numerical grid using the determined pore volume multiplier and the determined transmissibility multiplier.

### BRIEF DESCRIPTION OF THE DRAWINGS

FIG. 1 illustrates an example system for modifying pore volume and transmissibility in a numerical grid.

FIG. 2 illustrates one embodiment of a method of modifying pore volume and transmissibility in a numerical grid.

FIG. 3 illustrates a non-limiting example of a numerical grid, an area of interest (AOI), and a plurality of extensions, specifically four extensions.

FIG. 4 is a continuation of the non-limiting example of FIG. 3 with a focus on a plurality of edge bands, specifically four edge bands.

FIG. 5A is a continuation of the non-limiting example of FIGS. 3-4 with a focus on determining transmissibility consistent with the instant disclosure.

FIG. 5B is an alternative to FIG. 5A with a focus on determining transmissibility consistent with the instant disclosure.

FIG. 6 illustrates a mechanistic model used as a Reference Case. The Reference Case has 250 gridblocks in the X direction.

FIG. 7 illustrates a subset of 50 grid blocks from the Reference Case with a numerical aquifer in the last grid block to emulate the last 200 gridblocks of the Reference Case.

FIG. 8 illustrates the Reference case (black dots) and Case 1 comparison of bottom hole pressure (BHP). Case 1, with a single pore volume multiplier of 200 shows less pressure increase at the well through the injection period and more rapid rate of pressure decline in the post-injection period. A hypothetical maximum injection pressure (MIP) of 6000 psia is shown to demonstrate that Case 1 would be capable of injecting the scheduled volume, whereas the Reference Case would not.

FIG. 9 illustrates a Case 2, Reference Case (black dots), and Case 1 comparison of BHP at the injection well. Case 2, with a single pore volume multiplier of 201 and attenuated transmissibility, illustrates more pressure increase at the well through the injection period. A hypothetical maximum injection pressure (MIP) of 6000 psia is shown to demonstrate that Case 2 would be capable of injecting even less of the scheduled volume when compared to the Reference Case and Case 1.

FIG. 10A illustrates pore volume for Case 3.

FIG. 10B illustrates transmissibility for Case 3.

FIG. 11 illustrates a generalized form of the transmissibility attenuation equations for sequential gradational pore volume multipliers.

FIG. 12 illustrates a Case 3, Reference Case (black dots), Case 2, and Case 1 comparison of BHP at the injection well. Case 3, with gradational pore volume & transmissibility multipliers, improves the match of the model to the Reference Case when compared to the other two approaches.

FIG. 13 illustrates a simulation model error due to 1 band parametrization of the boundary pore volume enhancement region for a range of pore volume and transmissibility multiplier values.

FIG. 14 illustrates a simulation model error (compared to the Reference Case) due to number of attenuation bands and common ratio “r” for pv multiplier values of 200 (left) and 100,000 (right).

FIG. 15A illustrates Table 3. Pore volume multiplier and resulting I-direction transmissibility multiplier attenuation for each band of cells for a given attenuation method (showing case with desired total PV multiplier of 10,000 spread over 5 bands).

FIG. 15B illustrates a ore volume multiplier and resulting I-direction transmissibility multiplier attenuation for each band of cells for a given attenuation method (showing case with desired total PV multiplier of 200 spread over 5 bands). Pore volume is adjusted in the numerical aquifer area defined by the 5 bands, transmissibility is adjusted in cells offset by i-1. The attenuation band 0 is the block adjacent to the numerical aquifer with no pore volume multiplier.

FIG. 16 illustrates an impact of pore volume multiplier attenuation method on injector BHP prediction quality for various magnitudes of pore volume multipliers and attenuation band counts.

FIG. 17 illustrates an impact of attenuation band count (showing 1, 3, 5 and 7 band cases) on modelling error for various magnitudes of pore volume multipliers and attenuation methods.

FIGS. 18A-18C illustrate three different scenarios of applying boundary conditions to a 3D mechanistic model. Specifically, FIG. 18A illustrates a single PV multiplier applied along two boundary edges with no transmissibility attenuation (blue), FIG. 18B illustrates a single PV multiplier applied along two boundary edges along with corresponding transmissibility attenuation (red), and FIG. 18C illustrates a gradational PV multiplier and gradational transmissibility multiplier applied over 4 bands along two boundary edges (green). Although only the X-direction transmissibility is shown in these figures, the Y-direction transmissibility is attenuated in the same fashion for the boundary edge opposite the injector. All remaining boundaries are treated as closed.

FIG. 19 illustrates an AOR in acres plotted over time from simulating 3D mechanistic models with different ways of applying numerical boundary conditions; a single PV multiplier applied along two boundary edges with no transmissibility attenuation (blue), a single PV multiplier applied along two boundary edges along with corresponding transmissibility attenuation (red), and a gradational PV multiplier and gradational transmissibility multiplier applied over 4 bands along two boundary edges (green) shown on both a linear (right) and semi-logarithmic (left) scale.

Like reference numerals refer to corresponding parts throughout the drawings. The figures are not drawn to scale.

### DETAILED DESCRIPTION OF EMBODIMENTS

Within the spectrum of Carbon Capture and Storage (CCS) solutions, geological storage in aquifer systems stands as a promising avenue, offering substantial potential for large-scale carbon sequestration. In addition to saline aquifers, mature hydrocarbon reservoirs could also be considered as viable carbon sequestration targets.

To have an accurate estimate of storage capacity for target formations, proper boundary conditions should be applied in dynamic fluid flow models for these projects. Boundary conditions also play a key role in determining pressure and temperature profiles within the reservoir directly impacting the pressure plume evolution and geomechanical risks associated with large scale CO₂ injection. Accurate reservoir pressure predictions in CO₂ storage projects have direct first-order impact on determining Area of Review (AOR).

Current practices utilizing dynamic modeling for CCS projects commonly consider an assortment of simplified boundary conditions that include open and closed boundaries. A closed or low-flow boundary may result in an increase in the rate of pressure build-up and influence the size and symmetry of the plume. These closed systems represent a compartmentalized geologic storage formation bound on all sides by low permeability formations, similar to what is often observed in hydrocarbon reservoirs. An open boundary represents an aquifer system that is part of a large sedimentary basin or is fed by meteoric recharge and can be characterized as an infinite acting aquifer, a large aquifer system, or as a constant pressure boundary.

Realistic boundary conditions ensure that models reflect actual field conditions, leading to more accurate predictions and a better understanding of reservoir behavior. This is vital for decision-making in the oil and gas industry, impacting reservoir management, production strategies, and recovery estimates.

Aquifers, as porous and permeable geological structures, play a pivotal role in storing CO₂ safely underground. The dynamic interplay between the injected CO₂ and the aquifer environment is influenced by boundary conditions-defining the limits within which the system operates. These conditions encapsulate the physical, chemical, and hydraulic constraints that shape the behavior of CO₂ within the aquifer, ultimately influencing storage efficiency and long-term containment.

There are different ways to implement aquifer systems in dynamic models: 1) Explicit aquifers are built into geocellular models and allow for appropriate characterization of the field geology. This approach generally results in extremely large models that can become numerically expensive and result in slow run times. 2) Analytical aquifers (e.g., Carter-Tracey, Fetkovich, Constant Pressure), on the other hand, can easily be implemented with strong theoretical quantification methodologies. Analytical aquifers often require the definition of simplifying geometric assumptions that may deviate from reality. These analytical models are also difficult to implement, requiring some inputs that might not be readily available, especially in the early phases of project life cycle. 3) Numerical aquifers are easy to implement and utilize simple methodologies to quantify their associated volume. These types of aquifers, however, are overly simple and one-dimensional by nature. In this disclosure, a more representative approach of implementing numerical aquifers in dynamic models is provided.

Described below are methods, systems, and computer readable storage media that provide a manner of modifying pore volume and transmissibility in a numerical grid. In one embodiment, the method includes a) obtaining a numerical grid for an area of interest (AOI) in a formation, wherein the numerical grid comprises edge bands, wherein the edge bands act as proxies to extensions of the formation, and wherein each extension has a corresponding total pore volume; b) for each extension, determining an edge band volume for each edge band; c) for each extension, determining a ratio using the total pore volume and a sum of the determined edge band volumes; d) for each extension, determining a pore volume to be added to each edge band responsive to the determined ratio; e) for each extension, determining a pore volume multiplier for each edge band using the determined edge band volume for that edge band and the determined pore volume for that edge band; f) for each extension, determining a transmissibility multiplier for each edge band using the determined pore volume multiplier for that edge band and the determined pore volume multiplier for an adjacent edge band; and g) modifying pore volume and transmissibility of each edge band in the numerical grid using the determined pore volume multiplier and the determined transmissibility multiplier. These embodiments are designed to be of particular use for running simulations for decision making.

As used herein, an “edge band” is defined as a collection of edge cells in the same logical column parallel to the face of the extension. There may be a plurality of edge bands, and these bands are ordered so that the largest index of the plurality of edge bands is at the edge of the numerical grid adjacent to the face of the extension. The term “attenuation band” is used synonymously with the term “edge band” herein.

As used herein, “edge cells” refer to a collection of grid blocks that reside in a single edge band in all three dimensions. The number of edge cells should be greater than 1.

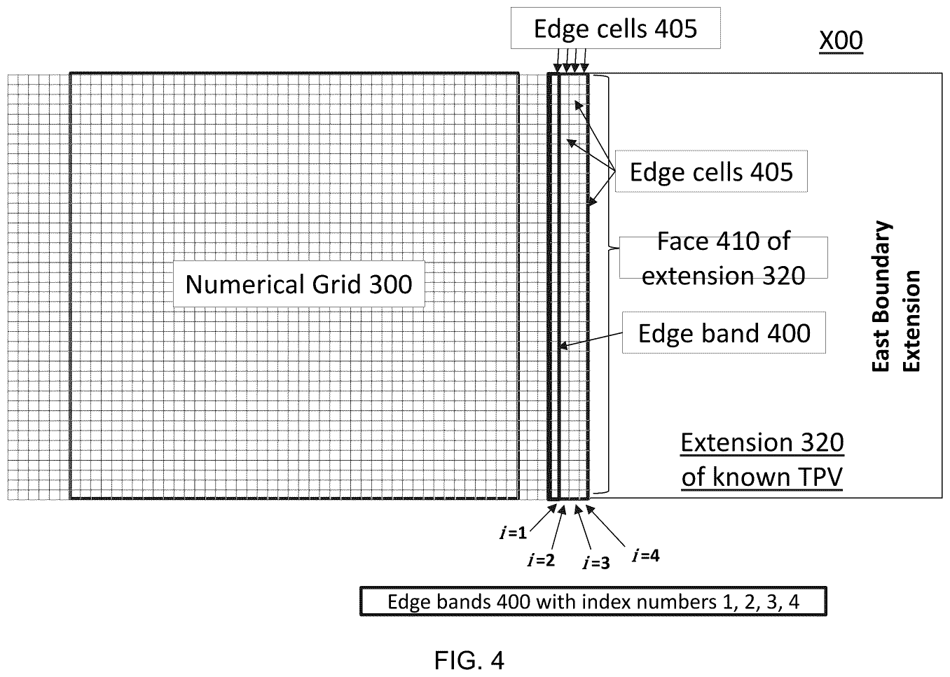

As used herein, a “face of an extension” is the side of the last edge band (e.g., i=4 in FIG. 4) beyond which there is no numerical grid. Beyond this point is the extension of known total pore volume (TPV).

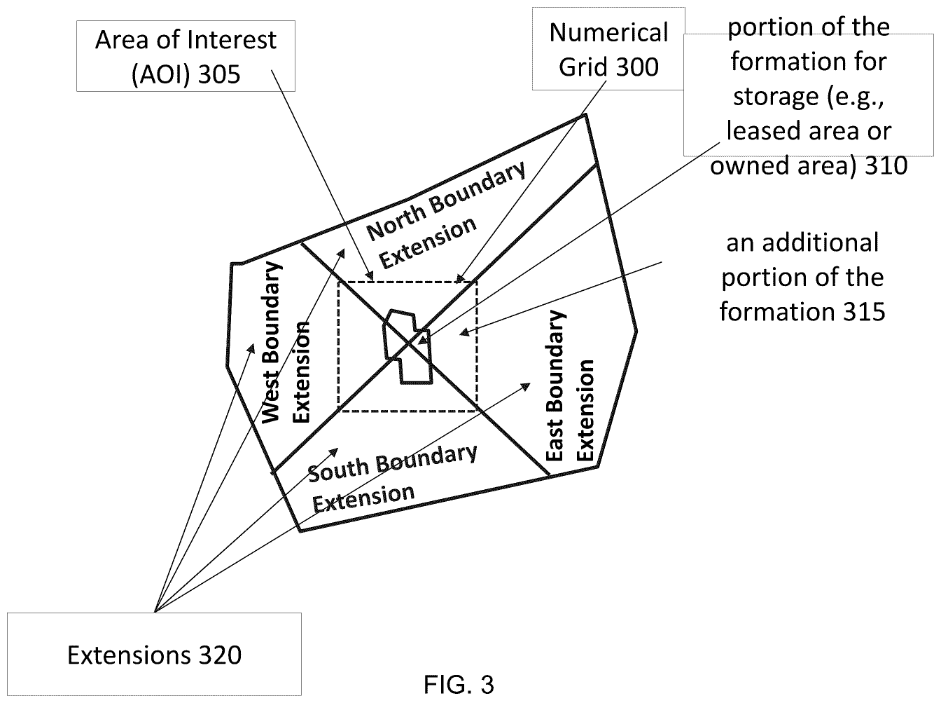

As used herein, a “numerical grid” is the 3D geocellular model built over the area of interest (AOI), inclusive of the edge bands. This numerical grid is typically described by the number of blocks in the X, Y, Z (alternatively I, J, K) as Nx*Ny*Nz (which would define the total number of grid blocks). The AOI may include a portion of a formation for storage (e.g., leased area or owned area) like carbon injection/storage. The AOI may also include an additional portion of the formation adjacent to the portion of the formation for storage (e.g., leased area or owned area) as illustrated in the non-limiting example in FIG. 3. Thus, the AOI may be larger than the portion for storage (e.g., leased area or owned area).

As used herein, an “extension” is an area where the formation exists, but the numerical grid does not cover. There may be a plurality of extensions in some embodiments, such as, but not limited to, two extensions, three extensions, four extensions as illustrated in the non-limiting example in FIG. 3, five extensions, ten extensions, twenty extensions, etc. However, there may be n number of extensions of the formation (e.g., northeast boundary, southeast boundary, northwest boundary, etc.), and the plurality of extensions may depend on geology, mapping with seismic, aerial extent, petrophysical properties, potential faults, etc. The formation not contained within the numerical grid is referred to as extensions. Consider the appropriate directional extensions based upon the geology and which side of the numerical grid each extension represents (for instance, if the formation is continuous all around the numerical grid, quantify the TPV in each of 4 directions if there are 4 extensions).

Advantageously, embodiments consistent with the instant disclosure may reduce modeling error for large total pore volume (TPV) additions. This disclosure suggests spreading the pore volume (PV) inflation over multiple edge bands and adjusting the transmissibility with multipliers (TM) as a function of the PV inflation.

Appropriately modeling how aquifer systems react to large scale CO₂ injection has relevance to potential geomechanical integrity, fault reactivation, etc. Static and dynamic models are generally built over a smaller portion of large saline aquifer system. This is typically tied to the balance between model size, fidelity, and computational expenses. Assigning the appropriate boundary conditions to replicate the true extent of the aquifer is investigated herein. Scoping the aquifer's size, geology, and properties is an important step that allows for the quantification of the appropriate pore volume beyond the area of the numerical model. Results herein indicate that using pore volume (PV) multipliers is a reasonable approach if accompanied by transmissibility reduction at the interface between the PV modifications and the reservoir model. A simple model was developed to create the true solution for comparison and verification purposes.

Based on the results herein, using a combination of PV and transmissibility multipliers replicates the true solution more accurately. This disclosure demonstrates that large PV adjustments without transmissibility reductions overestimates the true aquifer strength, resulting in overall lower pressures due to large-scale CO₂ injection. This disclosure demonstrates a systematic methodology for calculating the simultaneous PV increase and transmissibility reduction that scales easily for a wide range of scenarios.

Further investigation shows that as the PV multiplier grows large, the approach of reducing the transmissibility with a single multiplier starts to choke off the large added pore volume. This disclosure demonstrates that applying a gradually increasing PV multiplier combined with gradually reducing transmissibility is a more accurate representation of the true aquifer system when compared to a single large PV multiplier and a single transmissibility reduction. This approach was applied to large 3-D models and significant impact was observed in pressure diffusion front shape and extent when compared to more simplified approaches.

Assignment of boundary conditions for a variety of different scenarios were also investigated in this disclosure. It was shown that the approach herein may be a more accurate method of applying appropriate boundary conditions in obtaining reliable AOR forecasts when modeling large aquifer systems for CO₂ storage projects.

Reference will now be made in detail to various embodiments, examples of which are illustrated in the accompanying drawings. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatus have not been described in detail so as not to unnecessarily obscure aspects of the embodiments.

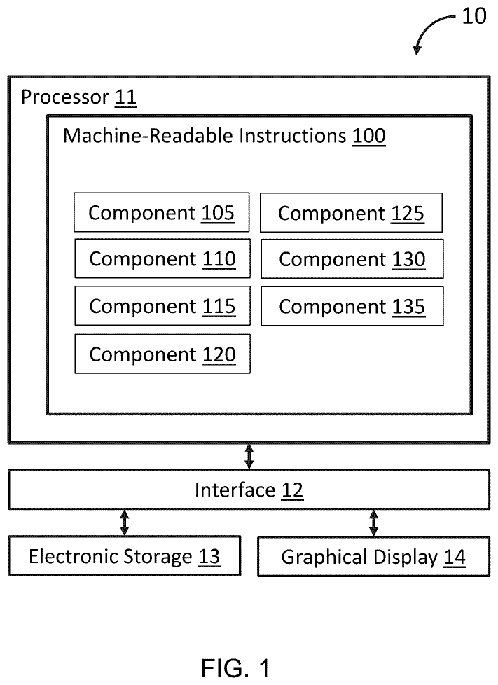

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, a graphical display 14, and/or other components.

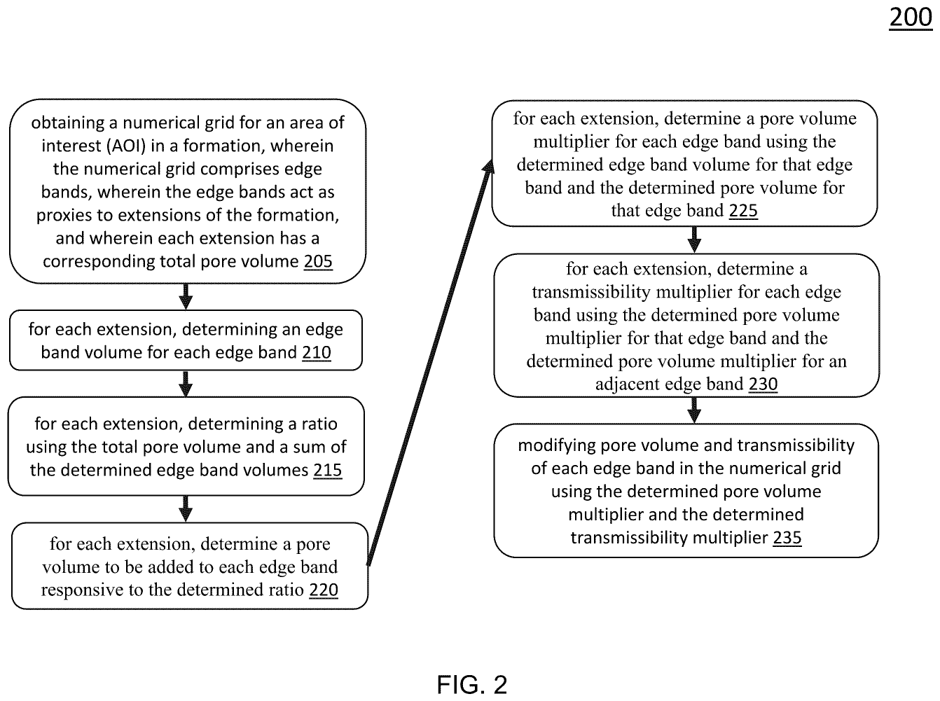

The electronic storage 13 may be configured to include any electronic storage medium that electronically stores information. The electronic storage 13 may store software algorithms, information determined by the processor 11, information received remotely, and/or other information that enables the system 10 to function properly. For example, the electronic storage 13 may store information relating to input such as numerical grid, total pore volume, total number of edge bands, and/or other information. For example, the electronic storage 13 may store information relating to output information relating to the modified pore volume and transmissibility of each edge band in the numerical grid (see step 235 in FIG. 2), stimulation results from using the numerical grid with the modified pore volume and transmissibility of each edge band, and/or other information. The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may include one or more non-transitory computer readable storage medium storing one or more programs. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

The graphical display 14 may refer to an electronic device that provides visual presentation of information. The graphical display 14 may include a color display and/or a non-color display. The graphical display 14 may be configured to visually present information. The graphical display 14 may present information using/within one or more graphical user interfaces. For example, the graphical display 14 may present information relating to the modified pore volume and transmissibility of each edge band in the numerical grid (see step 235 in FIG. 2), stimulation results from using the numerical grid with the modified pore volume and transmissibility of each edge band, intermediate values and/or results (e.g., determined edge band volumes, determined rations, determined pore volumes, determined pore volume multipliers, and/or determined transmissibility multipliers), and/or other information.

The processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate modifying pore volume and transmissibility in a numerical grid. The machine-readable instructions 100 may include one or more computer program components. The machine-readable instructions 100 may include a component 105, a component 110, a component 115, a component 120, a component 125, a component 130, a component 135, and/or other computer program components.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for case of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

Referring again to machine-readable instructions 100, the numerical grid component 205 may be configured to obtain a numerical grid for an area of interest (AOI) in a formation. The numerical grid comprises edge bands. The edge bands act as proxies to extensions of the formation. Each extension has a corresponding total pore volume.

The edge band volume component 210 may be configured to, for each extension, determine an edge band volume for each edge band.

The ratio component 215 may be configured to, for each extension, determine a ratio using the total pore volume and a sum of the determined edge band volumes.

The pore volume component 220 may be configured to, for each extension, determine a pore volume to be added to each edge band responsive to the determined ratio.

The pore volume multiplier component 225 may be configured to, for each extension, determine a pore volume multiplier for each edge band using the determined edge band volume for that edge band and the determined pore volume for that edge band.

The transmissibility multiplier component 230 may be configured to, for each extension, determine a transmissibility multiplier for each edge band using the determined pore volume multiplier for that edge band and the determined pore volume multiplier for an adjacent edge band.

The modification component 235 may be configured to modifying pore volume and transmissibility of each edge band in the numerical grid using the determined pore volume multiplier and the determined transmissibility multiplier.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

FIG. 2 illustrates an example method 200 for modifying pore volume and transmissibility in a numerical grid. For case of understanding, a non-limiting running example, generally illustrated in FIGS. 3-5, will be referenced in the discussion of the method 200.

At step 205, the method 200 includes obtaining a numerical grid for an area of interest (AOI) in a formation. The numerical grid includes edge bands. The edge bands act as proxies to extensions of the formation. Each extension has a corresponding total pore volume. Obtaining the numerical grid may include one or more of accessing, acquiring, analyzing, building, determining, examining, identifying, loading, locating, opening, receiving, retrieving, reviewing, selecting, storing, and/or otherwise obtaining the numerical grid. A new numerical grid may be built for the AOI in the step 205. Alternatively, the numerical grid may be previously built and used in the step 205. Alternatively, the numerical grid may be obtained from a third party or vendor, which built the numerical grid for the AOI. The numerical grid may be a three-dimensional grid. Practically any techniques known in the art may be utilized to build the numerical grid for the AOI. Consider the appropriate directional extensions based upon the geology and which side of the numerical grid each extension represents (for instance, if the formation is continuous all around the numerical grid, quantify the TPV in each of 4 directions if there are 4 extensions).

FIG. 3 illustrates a non-limiting example of a numerical grid 300, an area of interest (AOI) 305, and a plurality of extensions 320, specifically four extensions. In FIG. 3, one extension is for a north boundary, another extension is for an east boundary, another extension is for a south boundary, and another extension is for a west boundary. FIG. 4 is a continuation of the non-limiting example of FIG. 3 with a focus on a plurality of edge bands in the numerical grid 300. Four edge bands 400, index numbers i=1, i=2, i=3, and i=4, are illustrated in FIG. 4. Each edge band 400 has 43 edge cells 405. Face 410 of the extension 320 (corresponding to the East Boundary Extension) is the side of the last edge band (e.g., i=4 in FIG. 4) beyond which there is no numerical grid 300. Beyond this point is the extension 320 (corresponding to the East Boundary Extension) having a total pore volume (TPV). The TPV is already known for this extension 320 using mapping with seismic, considering aerial extent & assumed petrophysical properties, potential faults, etc.). The TPV may be simply estimated or using some other methodology known in the art.

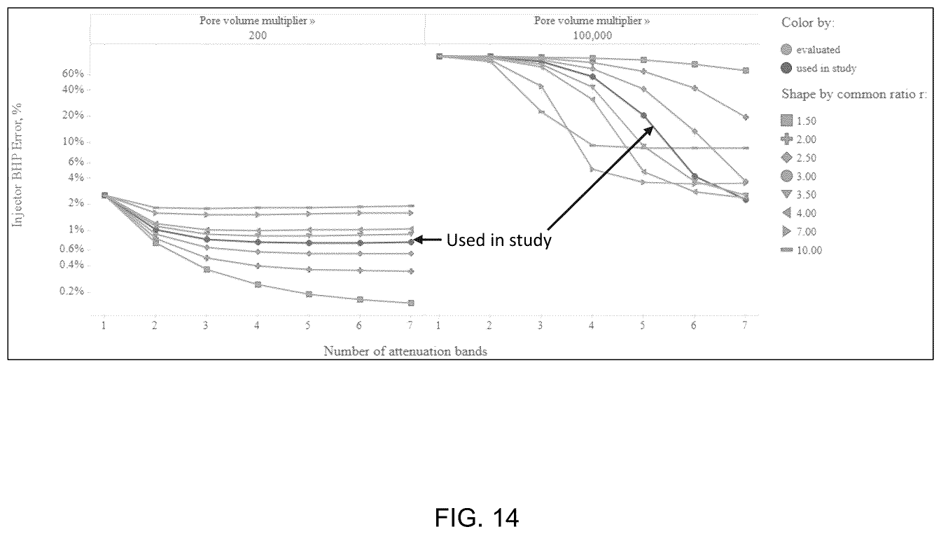

Of note, in one embodiment, the numerical grid 300 may be obtained as input. In one embodiment, the TPV of the extension 320 as well as the extension 320 may be obtained as input. In one embodiment, the total number of edge bands that will make up the plurality of edge bands 400 of the numerical grid 300 may be obtained as input. Regarding the total number of edge bands for the numerical grid, a variety of options are available. As a first option, four edge bands by may be utilized as a default starting point, and the number four may be received as input or the method 200 may be coded to automatically start with four edge bands. As another option, the total number of edge bands obtained as input may have been previously determined based on a sensitivity analysis using bottom hole pressure (BHP) error as discussed further hereinbelow (e.g., in the context of FIG. 14). Of note, FIG. 14 assumes that the basis of comparison is a numerical grid that also encompasses the extension, which is an expensive calculation. However, a similar approach may be utilized when the numerical grid does not cover the extension by modeling with four edge bands, and then adding additional edge bands, and tracking the incremental injector BHP error reduction per edge band addition until the injector BHP error reduction is no longer improved within a threshold acceptable to a user (e.g., 4%) (as shown on the right side of FIG. 14 when going from 6 edge bands to 7 edge bands as the threshold was crossed). As another option, the total number of edge bands obtained as input may have been previously determined based the following criterion. Option (A): Two edge bands may be utilized in some embodiments if the ratio is less than or equal to 1000 (e.g., indicative of a small extension) in step 220 discussed hereinbelow. Option (B): Four edge bands or more edge bands may be utilized in some embodiments if the ratio is more than 1000 (e.g., indicative of a large extension) in step 220 discussed hereinbelow.

At step 210, the method 200 includes, for each extension, determining an edge band volume for each edge band. In one embodiment, determining an edge band volume for each edge band comprises using an equation, and the equation is as follows:

$${EdgeBandVolume}_{i} = {\sum }_{j = 1}^{number of edge cells in 1 Edge Band} ( Dxj * Dyj * Dzj * Porosity j )$$

where EdgeBandVolume is an edge band volume for an edge band, i is edge band index number, j is edge cell index number, Dx is width, Dy is length, Dz is height, and Porosity is porosity for each edge cell.

Returning to the non-limiting example in FIGS. 3-5, an EdgeBandVolume may be determined for each edge band 400 through all corresponding edge cells 405 starting with the edge band 400 that is adjacent to the extension 320 (corresponding to the East Boundary Extension). Therefore, this example starts with determining the edge band volume for edge band 400 with index i=4, which is the edge band 400 adjacent to extension 320 (corresponding to the East Boundary Extension). EdgeBandVolume₄ may be determined for the edge band 400 with index i=4 through all corresponding edge cells 405 of this edge band. Next, EdgeBandVolume₃ may be determined for the edge band 400 with index i=3 through all corresponding edge cells 405 of this edge band. Next, EdgeBandVolume₂ may be determined for the edge band 400 with index i=2 through all corresponding edge cells 405 of this edge band. Next, EdgeBandVolume₁ may be determined for the edge band 400 with index i=1 through all corresponding edge cells 405 of this edge band. These edge band volumes may be determined using the equation in step 210. A similar approach may be utilized for the North Boundary Extension, the West Boundary Extension, and the South Boundary Extension in FIG. 3.

At step 215, the method 200 includes, for each extension, determining a ratio using the total pore volume and a sum of the determined edge band volumes. The total pore volumes corresponding to the extensions that were obtained at the step 205 may be utilized.

Returning to the non-limiting example in FIGS. 3-5, which has four edge bands, the ratio may be determined by total pore volume (TPV) of the extension 320 (corresponding to the East Boundary Extension) divided by the sum of EdgeBandVolume₁+EdgeBandVolume₂+EdgeBandVolume₃+EdgeBandVolume₄ using the equation in step 215. In other words, for this example, this step includes calculating the ratio of TPV/(EdgeBandVolume₁+EdgeBandVolume₂+EdgeBandVolume₃+EdgeBandVolume₄). For simplicity, the ratio may be referred to as TPV/4 EdgeBandVolume (TPV/4EBV) ratio herein. A similar approach may be utilized for the North Boundary Extension, the West Boundary Extension, and the South Boundary Extension in FIG. 3. Thus, there will be 4 ratios determined for this example.

At step 220, the method 200 includes, for each extension, determining a pore volume to be added to each edge band responsive to the determined ratio. This step may be performed in a variety of ways.

In one embodiment, determining a pore volume to be added to each edge band responsive to the determined ratio includes utilizing an arithmetic approach if the ratio is less than or equal to 1000. In other words, if the TPV/4EBV is =<1000, then use the arithmetic approach to calculate the PV to be added to each edge band. In one embodiment, the arithmetic approach includes using an equation to calculate pore volume (PV) to be added for each edge band, and the equation is as follows:

$$P {V}_{i} = i * \frac{2 ( T P V )}{{N}_{b a n d s} * ( {N}_{b a n d s} + 1 )}$$

where i is edge band index number, N_{bands} is total number of edge bands, and TPV is Total Pore Volume.

Returning to the non-limiting example in FIGS. 3-5, which has four edge bands, PV₁ may be determined for the edge band 400 with index i=1, PV₂ may be determined for the edge band 400 with index i=2, PV₃ may be determined for the edge band 400 with index i=3, and PV₄ may be determined for the edge band 400 with index i=4 using the arithmetic approach if the ratio is less than or equal to 1000 as in step 220. A similar approach may be utilized for one or more of the North Boundary Extension, the West Boundary Extension, and/or the South Boundary Extension in FIG. 3 depending on their corresponding determined ratios.

In one embodiment, determining a pore volume to be added to each edge band responsive to the determined ratio includes utilizing a geometric approach if the ratio is more than 1000. In other words, if the TPV/4EBV is >1000, then use the geometric approach to calculate the PV to be added to each edge band. In one embodiment, the geometric approach includes using an equation to calculate pore volume (PV) to be added for each edge band, and the equation is as follows:

$$P V i = \frac{( {r}^{i} )}{{S}_{{N}_{b a n d s}}} * ( T P V )$$

where i is edge band index number, r is root of 3, TPV is Total Pore Volume and S_{Nbands} is calculated as S_{N}_{_{bands}}=Σⱼ₌₁^{N}^{_{bands}} r^{j} where N_{bands} is total number of edge bands, r is root of 3.

Returning to the non-limiting example in FIGS. 3-5, which has four edge bands, PV₁ may be determined for the edge band 400 with index i=1, PV₂ may be determined for the edge band 400 with index i=2, PV₃ may be determined for the edge band 400 with index i=3, and PV₄ may be determined for the edge band 400 with index i=4 using the geometric approach if the ratio is more than 1000 as in step 220. A similar approach may be utilized for one or more of the North Boundary Extension, the West Boundary Extension, and/or the South Boundary Extension in FIG. 3 depending on their corresponding determined ratios.

Of note, it is possible to use both equations in the running example because the equations are based on the determined ratios.

At step 225, the method 200 includes, for each extension, determining a pore volume multiplier (PVM) for each edge band using the determined edge band volume for that edge band and the determined pore volume for that edge band. In one embodiment, determining a pore volume multiplier for each edge band using the determined edge band volume for that edge band and the determined pore volume for that edge band includes using an equation, and the equation is as follows:

$$P V {M}_{i} = \frac{P {V}_{i} + {EdgeBandVolume}_{i}}{{EdgeBandVolume}_{i}}$$

where i is edge band index number, PV is pore volume to be added, EdgeBandVolume is edge band volume, and PVM is pore volume multiplier.

Returning to the non-limiting example in FIGS. 3-5, which has four edge bands, PVM₁ may be determined for the edge band 400 with index i=1, PVM₂ may be determined for the edge band 400 with index i=2, PVM₃ may be determined for the edge band 400 with index i-3, and PVM₄ may be determined for the edge band 400 with index i=4 using the equation in step 225. A similar approach may be utilized for the North Boundary Extension, the West Boundary Extension, and the South Boundary Extension in FIG. 3.

At step 230, the method 200 includes, for each extension, determining a transmissibility multiplier for each edge band using the determined pore volume multiplier for that edge band and the determined pore volume multiplier for an adjacent edge band. The direction of the PV additions is accounted for in the transmissibility attenuation (as transmissibility is a direction dependent property).

In one embodiment, determining transmissibility multiplier (attenuation) for each edge band using the determined pore volume multiplier for that edge band and the determined pore volume multiplier for an adjacent edge band includes using an equation, and the equation is as follows if the extension is located at the last grid block index (Nx) of Nx grid blocks:

$$T {M}_{i} = \frac{2}{( P V {M}_{i} + P V {M}_{i + 1} )} starting at block Nx - N bands$$

where i is edge band index number, PVM is pore volume multiplier, and TM is transmissibility. This equation above should be utilized when the extension is adjacent to the Nx face.

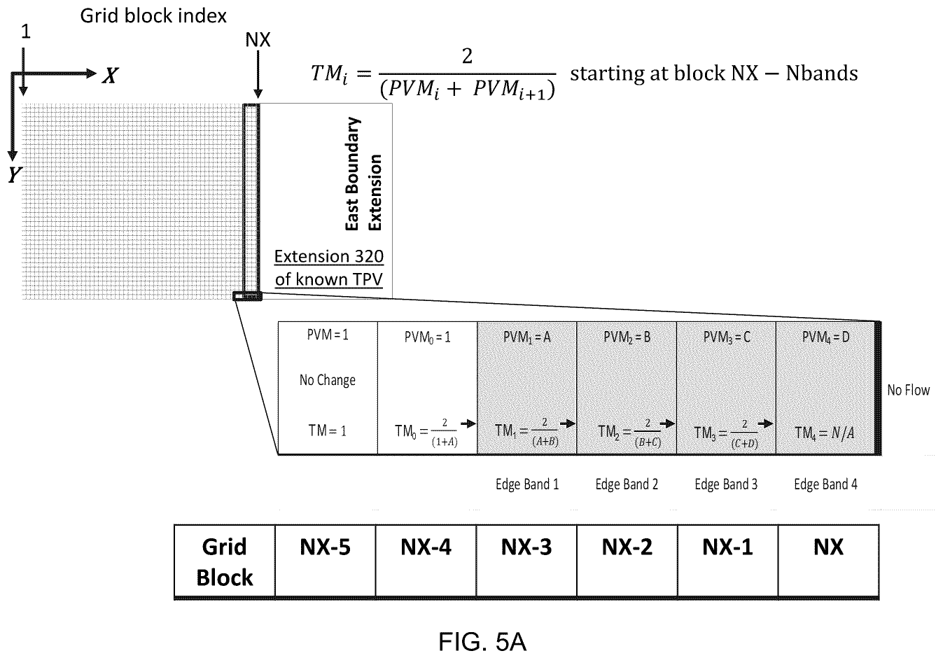

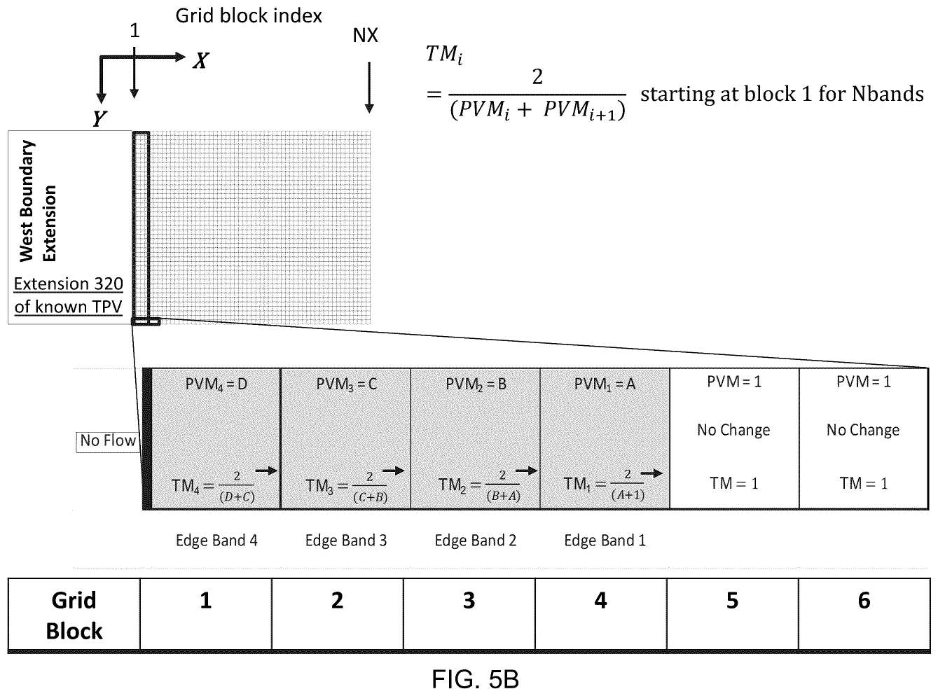

Returning to the non-limiting example in FIGS. 3-5, the PVMs start at edge band 1 (i.e., i=1), however the transmissibility, a directional property as indicated by the black arrows, is modified starting in the cell just to the left of edge band 1 (labeled TMo). For the PVMs, D>C>B>A>1. FIG. 5 illustrates how to determine the TM of each of the four edge bands using the equation in step 230. NX is the total number of gridblocks in the X-direction, N_{bands} is 4, and i is the edge band index number. And, as illustrated, the extension 320 (corresponding to the East Boundary Extension) is located to the right of the edge bands in FIGS. 4-5. A similar approach may be utilized for the South Boundary Extension in FIG. 3, and this assumes an increasing grid block index progression from north to south.

In one embodiment, determining a transmissibility multiplier (attenuation) for each edge band using the determined pore volume multiplier for that edge band and the determined pore volume multiplier for an adjacent edge band includes using an equation, and the equation is as follows if the extension is located at the first grid block index (1) of Nx grid blocks:

$$T {M}_{i} = \frac{2}{( P V {M}_{i} + P V {M}_{i + 1} )} starting at block 1 for N band$$

where i is edge band index number, PVM is pore volume multiplier, and TM is transmissibility.

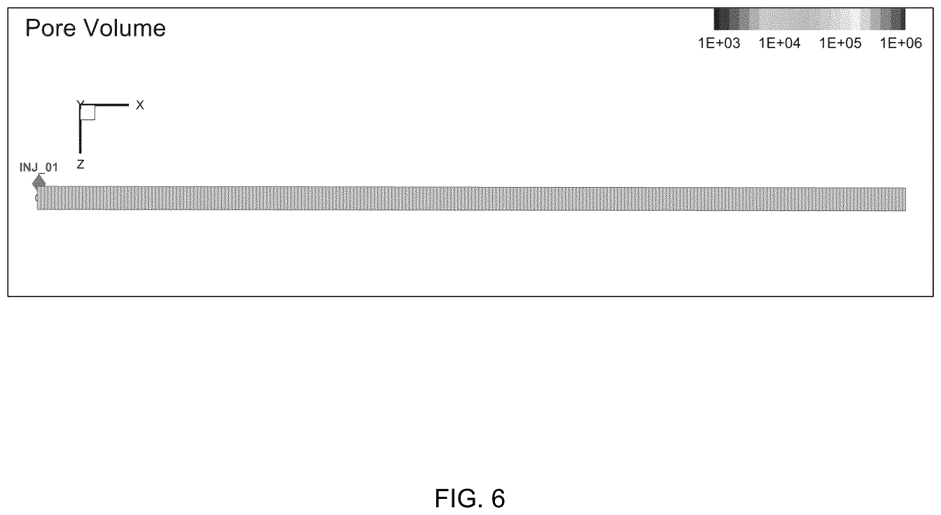

Turning to FIG. 6, this figure illustrates how to determine the TMs of each of the four edge bands using the equation in step 230 if the extension is in the opposite direction, such as to the left of the edge bands. In this alternative non-limiting example, from left to right, the PVMs & TMs start at edge band 4 with no shift in transmissibilities. For the PVMs, D>C>B>A>1. N_{bands} is 4 and i is the edge band index number. A similar approach may be utilized for the North Boundary Extension in FIG. 3, and this assumes an increasing grid block index progression from north to south.

At step 235, the method 200 includes modifying pore volume and transmissibility of each edge band in the numerical grid using the determined pore volume multiplier (from the step 225) and the determined transmissibility multiplier (from the step 330) for that edge band.

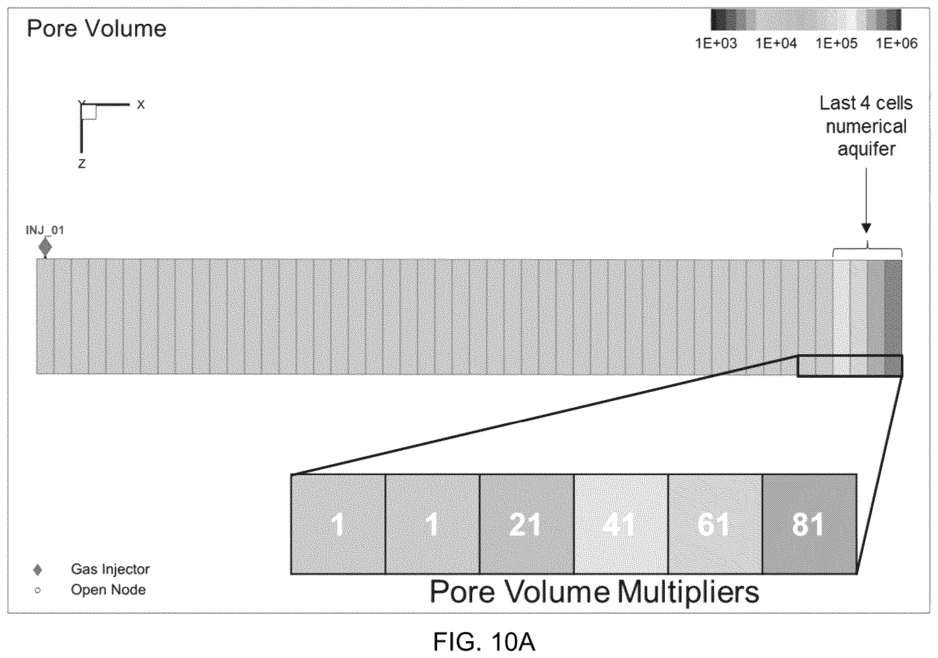

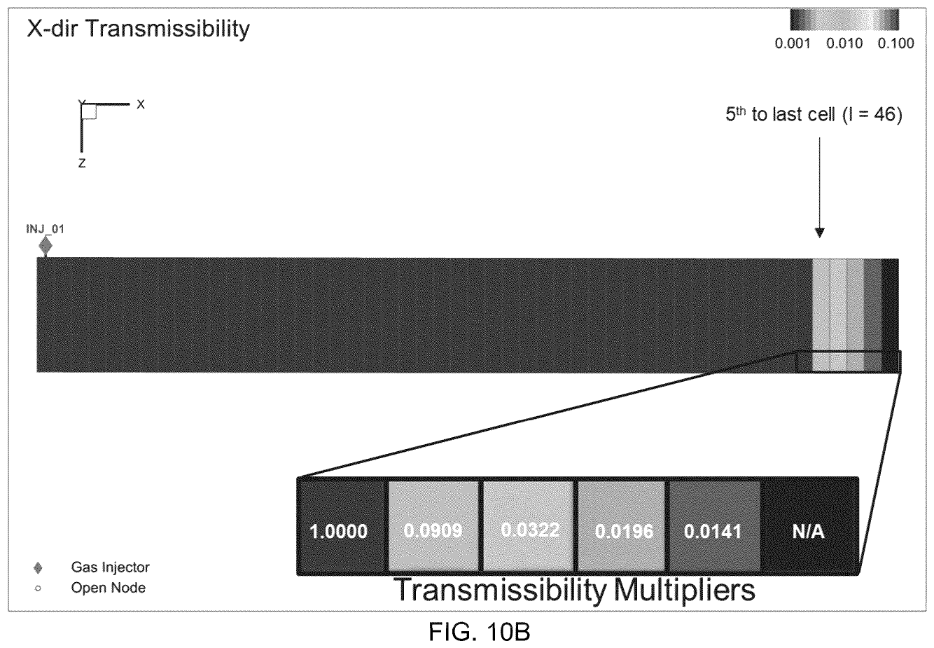

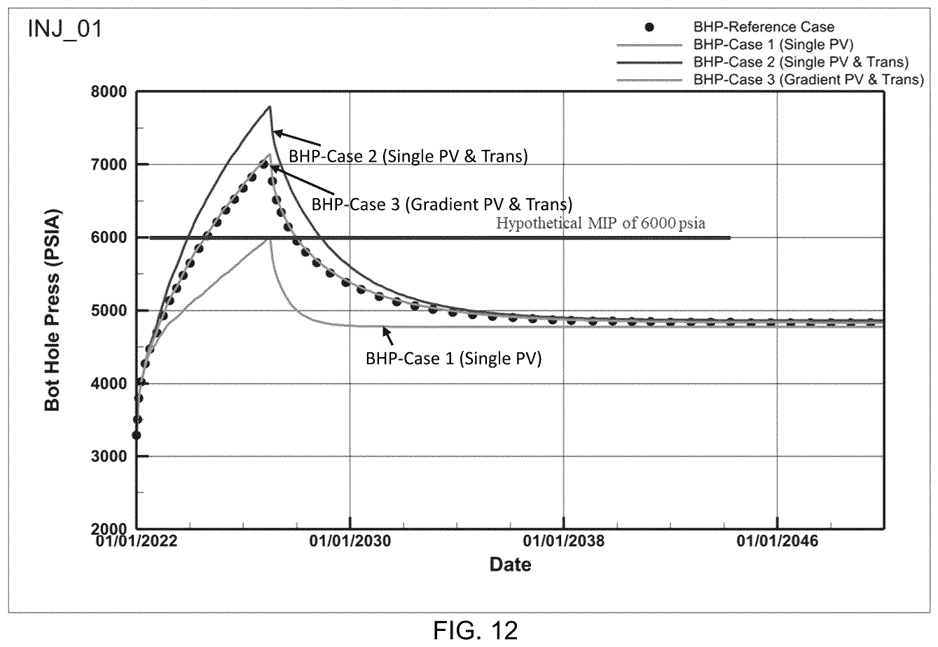

The pore volume and transmissibility properties of each edge band may be modified in the numerical grid, thus, leading to more accurate results. FIGS. 10A and 10B described herein are illustrative. FIG. 12 is also illustrative and discusses a Case 3, a Reference Case (black dots), Case 2, and Case 1 comparison of BHP at the injection well. Case 3, with gradational pore volume & transmissibility multipliers as discussed herein, improves the match of the model to the Reference Case when compared to the other two approaches.

After the modifications, the numerical grid may be utilized for simulations, etc. Many decisions related to carbon injection and storage, produced water injection and storage, hydrocarbon recovery, compliance with government entities such as in the context of carbon injection and storage, etc.

Additional information may be found in Ghomian, Y., et al. “Applying Boundary Conditions for Large Aquifer Models in Geological CO₂ Storage Projects; Why and How?” SPE-220913-MS, Paper presented at the SPE Annual Technical Conference and Exhibition, New Orleans, Louisiana, USA, September 2024, which is incorporated by reference in its entirety.

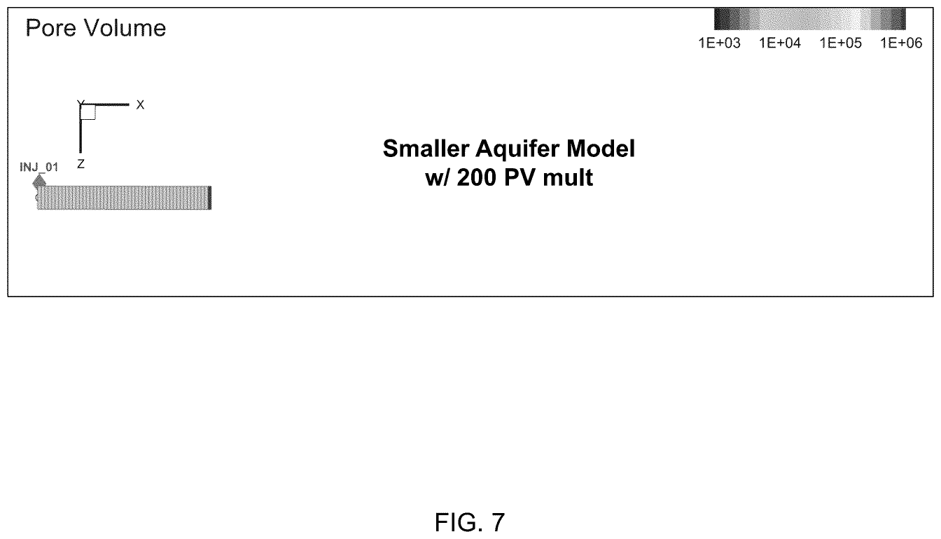

Aquifer Boundary Implementation in a Mechanistic Model—To put this approach into practice, a simple mechanistic two-dimensional aquifer model is built. The objective is to create a large aquifer model used as the reference or truth case. In this example, the model constructed is 250 gridblocks in the X direction, 5 gridblocks in the Y direction, and 1 grid block in the Z direction. FIG. 6 shows a cross-section view of the mechanistic large aquifer model used for this study. Table-1 shows the dimensions of the large aquifer model. FIG. 7 is the smaller subset of this model with a numerical aquifer implemented in the last cell. This smaller model is used throughout this study with different numerical aquifer configurations. Table-2 shows the dimensions of the smaller subset model for the first example.

The smaller model is used as a proxy for the real-world practice where a small geographic area of a large basin-wide aquifer is built for the purposes of testing carbon sequestration development plans. As a general practice, when using numerical aquifers, the aquifer volume is added to the model edge using pore volume and (sometimes) transmissibility multipliers instead of modeling the entire aquifer. The objective of this exercise is to test the sensitivity of different numerical aquifer configurations and their ability to match the reference or truth case (the large aquifer model). The large aquifer model is 37500 ft long. CO₂ is injected using a single injection well for 5 years at a rate of 40 reservoir barrels per day. The smaller subset of this model is 7500 ft long with a pore volume multiplier in the last cell(s) to represent the missing 30000 ft, with the same injection plan. All cases investigated using this smaller subset model have the same total pore volume as the reference case.

During CO₂ injection it is important to keep injection pressure in the reservoir below the fracture or parting pressure of the injection and confining zones. This is especially important at the point of injection. Pressure rising above the fracture pressure of the confining zone could lead to a breach and loss of CO₂ containment. Additionally, there are geomechanical risks such as fault reactivation, fracture propagation, etc. Pressure is expected to be the highest at the point of injection. In the United States sequestration operators are required to keep the injection pressure below the maximum injection pressure (MIP), defined as the maximum pressure at the wellhead that assures the pressure in the injection zone does not initiate new fractures or propagate existing fractures in either the injection zone or the confining zone. As a result, operators are required to monitor pressure at the point of injection (which doesn't preclude monitoring pressure further away from the point of injection).

Boundary conditions can impact the pressure within the reservoir and at the point of injection. Bottom hole pressure response is used as the observed variable to judge match quality between the reference case and the cases shown in this comparison.

TABLE 1
Dimensions of the large aquifer model
used to generate the reference case.

| | |
|---|---|
| Model Length, ft | 37500 |
| Model Width, ft | 750 |
| Cells size in I and J directions, ft | 150 |
| Number of cells in I, J directions | 250, 5 |

TABLE 2
Dimensions of the subset model used to test numerical
aquifers and compare to the reference case.

| | |
|---|---|
| Model Length, ft | 7500 |
| Model Width, ft | 750 |
| Cells size in I and J directions, ft | 150 |
| Number of cells in I, J directions | 50, 5 |
| PV mult on the last cell | 201 |

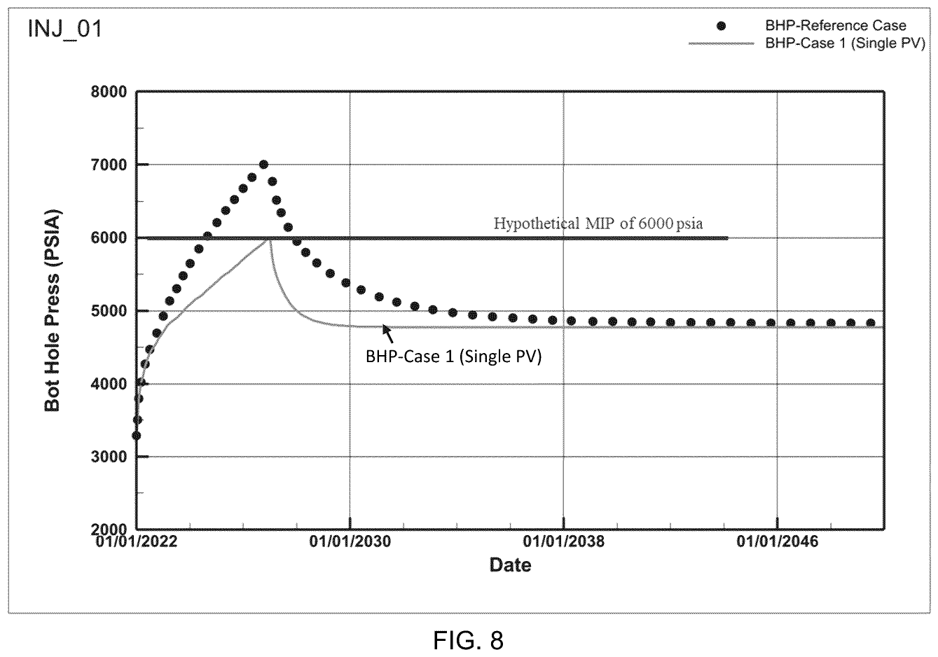

Reference Case & Case 1 (Pore Volume Only)—Both the reference case and Case 1 inject CO₂ for 5 years followed by 10 years of post-injection observation. During the entire 15 years, the bottom hole pressure of the well is observed and used as the proxy for pressure within the reservoir and match quality. FIG. 8 compares the reference case (black dots) and Case 1 where a single pore volume multiplier of 201 is used as the numerical aquifer. The addition of a single pore volume (e.g., 201 to represent 200 grid blocks) to the targeted cells is required to account for the pore volume of the cell within the model, as well as the 200 volumes being attached. Case 1 shows a lower rate of pressure increasing during injection and a more rapid rate of pressure drop during the post-injection period. This is due to the inflation of the pore volume in the last grid block that is still using the transmissibility of the original grid block that is 150 feet long in the X-direction. The larger pore volume located near the edge of the model makes the aquifer more easily capable of absorbing pressure, resulting in lower pressure at the injection well and throughout the model. If the maximum injection pressure (MIP) of this formation or confining zone was 6000 psia, in the reference case a hypothetical operator would be required to inject less CO2 whereas in Case 1 the same operator would be able to inject the full volume of CO2. This simple mechanistic model demonstrates one way to implement a numerical aquifer, where the pore volume of the last grid block(s) is adjusted, with no changes to transmissibility.

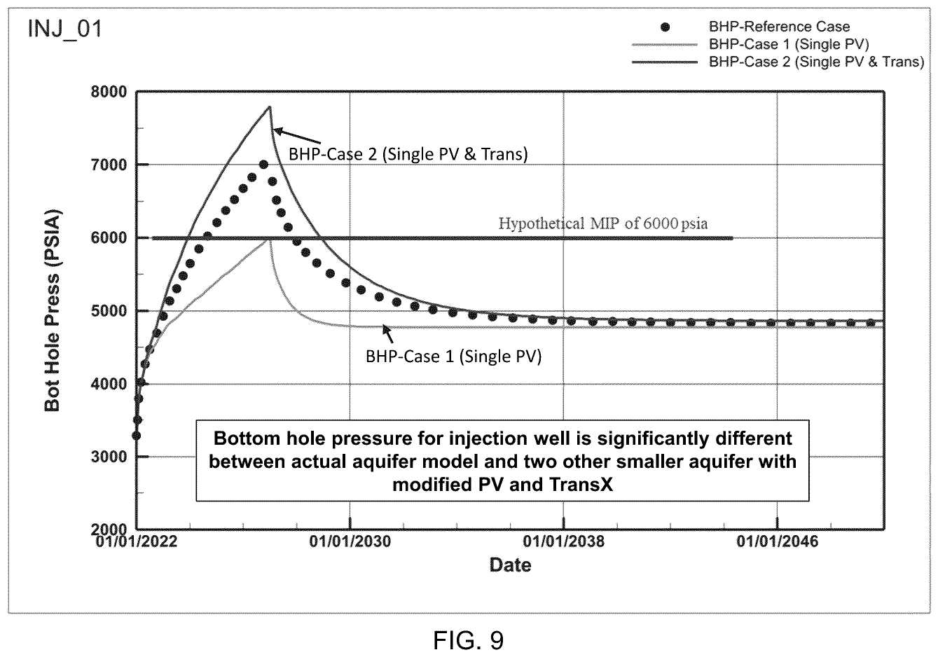

Case 2 (Pore Volume and Transmissibility)—The next numerical aquifer investigated uses the same pore volume multiplier with the addition of a multiplier that attenuates the transmissibility connection between the numerical aquifer and the rest of the model. The transmissibility is attenuated in accordance with the assumptions of unidirectional expansion outlined in the section titled, “Aquifer Boundary Condition Implementation”. FIG. 9 shows the results of Case 2 in comparison to Case 1 and the reference case. Case 2 shows that the addition of the transmissibility attenuation creates a more rapid rise in pressure during injection, achieving a higher pressure (˜7800 psia) just before the end of injection. Comparing Case 2 and Case 1 to the reference case, show that neither case does a sufficient job of matching the reference case. Applying the same maximum injection pressure (MIP) constraint of 6000 psia to Case 2 would require a hypothetical operator to inject less CO2 than in the reference case whereas a hypothetical operator using Case 1 would be capable of injecting the entire scheduled volume. This occurs because the single transmissibility multiplier used to attenuate the connection & make the inflated pore-volume more distal chokes the connection off too much between the numerical aquifer and the model.

These two sensitivities show that both approximations are incorrect. From an operator's perspective, the approach in Case 1 of only using the PVM results in a system with more capacity for CO2 whereas the approach in Case 2 results in a system with less capacity for CO2. The reference case is in between the two cases.

Case 3 (Gradational Pore Volume and Transmissibility)—The third numerical aquifer investigated is one where both the pore volume and the transmissibility are gradually changed over the last several cells in the subset model. The pore volume is gradually changed in the last 4 cells, starting with a multiplier of 21 and then increasing the multiplier linearly by increments of 20 for pore volume multipliers of 21, 41, 61, 81 (recall the need to add an additional 1 pore volume per cell used to account for the cell(s) being used for the numerical aquifer). The transmissibility change starts with the 5th to last cell because transmissibility is a face dependent variable. The 5th to last cell (I=46) transmissibility controls the connection between that cell and the first cell in the numerical aquifer for Case 3. FIG. 10 shows both the pore volume and the X direction transmissibility for Case 3.

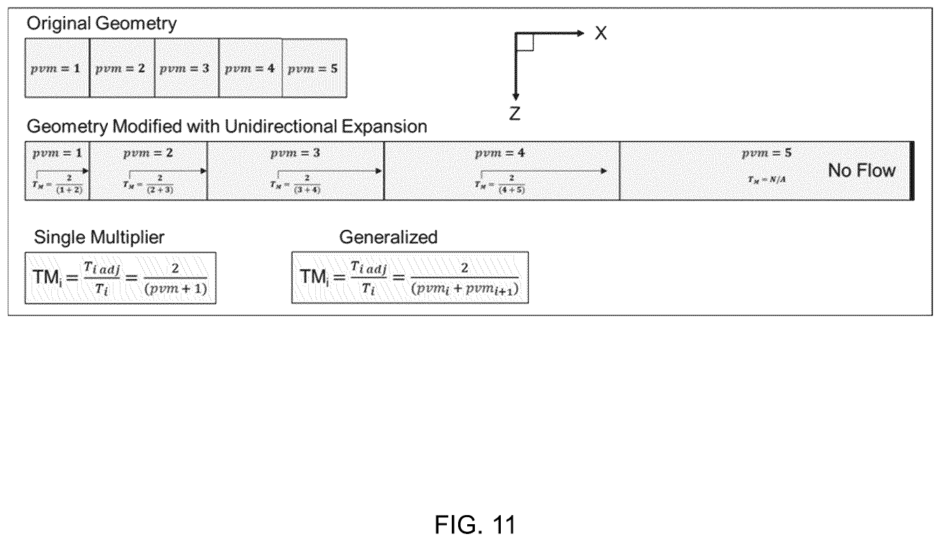

The generalized approach and calculation used for gradational transmissibility multipliers is shown in FIG. 11 and is illustrated with an example where the pore volume multipliers are 2, 3, 4, 5. Starting with the 5th to last cell (with no pore volume multiplier), calculate that cell transmissibility multiplier using the generalized form, where TMᵢ is 2 divided by the sum of the pore volume multiplier for cells i and i+1. The last cell contains no transmissibility multiplier because it is a no flow boundary. In this case, the pore volume and transmissibilities are consistently applied in the same direction. If the direction of the application varies, the formula requires modification considering the directional nature of transmissibilities.

Case 3 bottom hole pressure matches the reference case very well and is shown in FIG. 12. The gradational approach is an improvement over Case 1 and Case 2.

Mechanistic Results Discussion—These simple experiments show that using a gradational approach to modeling numerical aquifers is an improvement over the other approaches. A few observations that can be made at this point are below.

Case 1 (single pore volume multiplier approach)
Can underestimate the AOR and increase in pressure when injecting CO₂
(or other fluids) due to the proximal nature of the additional pore volume
added.
When implementing larger pore volumes this modeling approach can
begin to behave like a constant pressure outer boundary.
Case 2 (single pore volume multiplier with attenuated transmissibility)
Can overestimate the AOR and increase in pressure when injecting CO₂,
especially as the transmissibility attenuation becomes smaller with large
pore volume multipliers.
When implementing very large pore volume multipliers, this approach
will begin to become less effective due to the small transmissibility
connecting the aquifer. This approach will begin to behave as a closed
outer boundary situation in the extreme cases.
Case 3 (gradational pore volume
multiplier and transmissibility attenuation)
An improvement on estimating the increase in pressure when injecting
CO₂ or any other fluid types.
Reproduces the physics of the system when compared to the reference
case.
Requires further investigation.

The gradational method applied for Case 3 is a simple algebraic progression using an arbitrary number of grid blocks (or bands) to model the numerical aquifer. The authors wanted to investigate the sensitivity of this approach to the number of gridblocks used, the size of the numerical aquifer, and the algorithm for the gradation of the pore volume and transmissibility multipliers.

Estimation of error methodology-Moving forward an error function (Equation below) was set up to objectively track the accuracy of the numerical aquifer approaches compared to the reference case.

$$Injection B H P Error , \% = \frac{\sum w * \frac{\vert B H {P}_{o b s} - B H {P}_{s i m} \vert}{B H {P}_{o b s}}}{\sum w}$$

where BHP_{obs} is the observed reference injector BHP shown in FIG. 12, BHPₛᵢₘ—simulated injector BHP, w-data point weights. For this study all data points were weighted equally w=1.

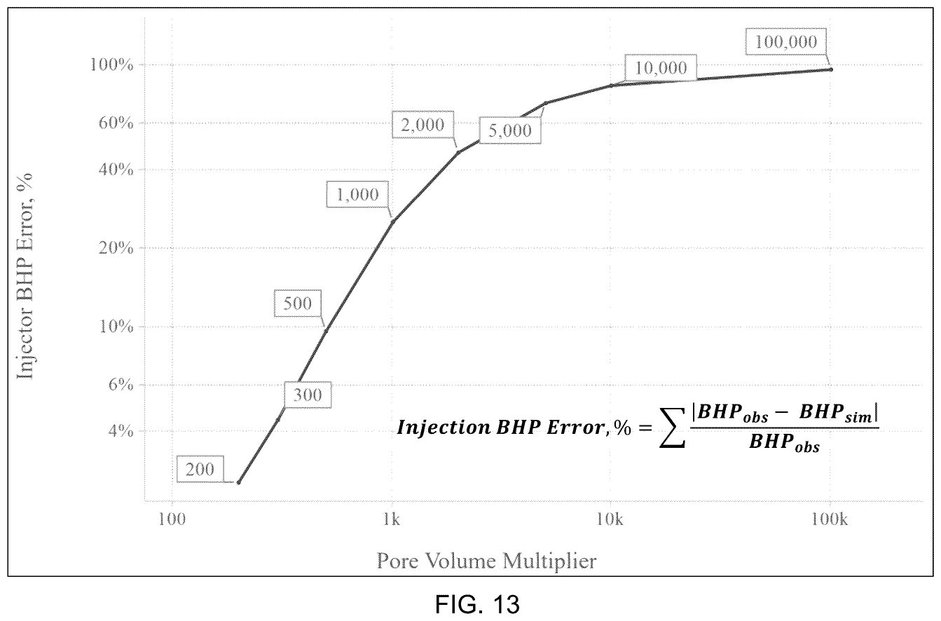

Generalization of Approach for Gradational PV and Trans Multiplier—While the use of a single band of cells pore volume and transmissibility multiplier adjustments is common in the industry, FIG. 13 shows that the modelling error increases dramatically for pore volume multipliers greater than 500, reaching as much as 50-90% for multipliers in the thousands or tens of thousands. The reduced transmissibility multipliers in the primary flow direction are unable to appropriately control the flow of these increased volumes and a gradual pore volume multiplier attenuation is needed. When selecting the methods for pore volume and transmissibility multiplier gradation, the objective is to investigate the different approaches and identify the best performing ones with consideration given to the pore volume magnitude being approximated. Methods considered in this study were:
Constant progression (uniform)

$$P V {M}_{i} = \frac{( P V M + {N}_{b a n d s} )}{{N}_{b a n d s}}$$

Arithmetic progression (linear)

$$P V {M}_{i} = i * \frac{2 ( P V M + {N}_{b a n d s} )}{{N}_{b a n d s} * ( {N}_{b a n d s} + 1 )}$$

Quadratic progression

$$P V {M}_{i} = \frac{( i + {i}^{2} )}{{S}_{{N}_{b a n d s}}} * ( P V M + {N}_{bands} )$$

$$where$$

$${S}_{{N}_{bands}} = {\sum }_{j = 1}^{{N}_{bands}} ( j + {j}^{2} )$$

S_{Nbands} is evaluated for all j (bands) prior to calculating PVM; and is used to normalize the progression of pore volume multipliers.
Geometric progression

$$P V {M}_{i} = \frac{( {r}^{i} )}{{S}_{{N}_{bands}}} * ( P V M + {N}_{bands} )$$

$$where$$

$${S}_{{N}_{bands}} = {\sum }_{j = 1}^{{N}_{bands}} {r}^{j}$$

S_{Nbands} is evaluated for all j (bands) prior to calculating PVM; and r is the common ratio of the geometric progression.

In all the approaches above, the pore volume multiplier is applied by band with the notation of “i” (e.g. PVM₁, PVM₂, represent the multipliers for band 1, band 2 respectively, where band 1 is closest to the non-modified cells). S_{Nbands} is always evaluated prior to the geometric progression for the total number of bands used.

Before commencing the comparative study of different methodologies, the study tested the impact of the common ratio value in the geometric progression for cases with PVM=200 and PVM=100,000. FIG. 14 demonstrates that a common ratio of 3 performs best for both small and large pore volume multipliers. For small pore volumes a low common ratio performs best, but for larger pore volumes in this example, small common ratios fail to result in a significant error reduction.

In all instances the (PVM+N_{bands}) term increases the base PVM value to account for the native unit volume of the boundary cells being modified. Transmissibility multipliers are calculated the same for all attenuation methods:

$$T {M}_{i} = \frac{2}{P V {M}_{i} + P V {M}_{i + 1}}$$

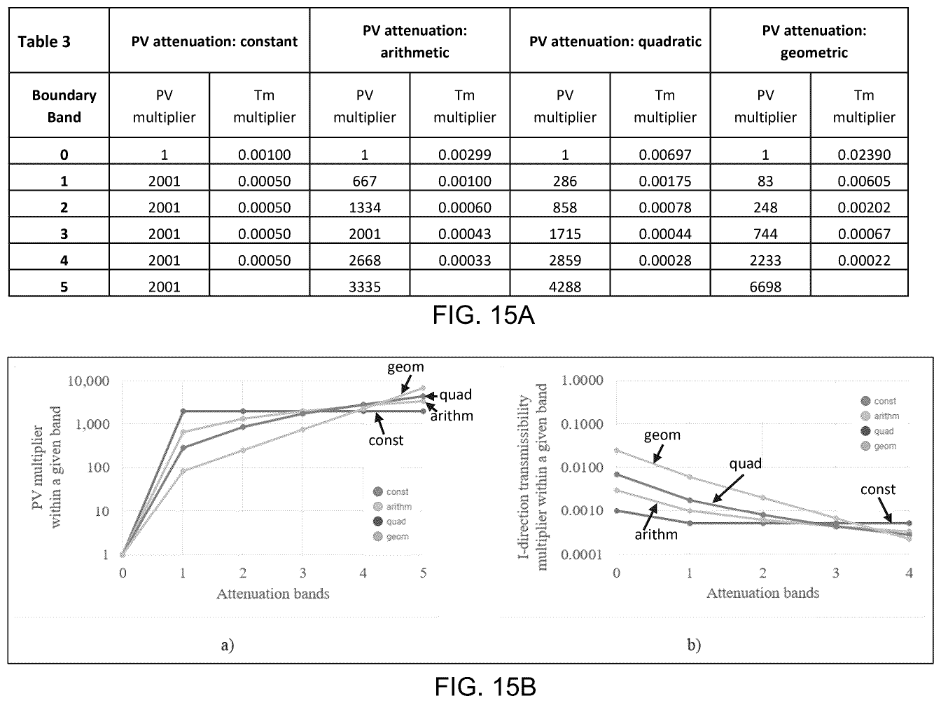

Table 3 demonstrating the nature of PV multiplier attenuation and values of the corresponding transmissibility multipliers based on the attenuation method used in a case where the boundary region was discretized using 5 bands of cells. Plots of the data presented in Table 3 (FIG. 15A) is displayed in FIG. 15B.

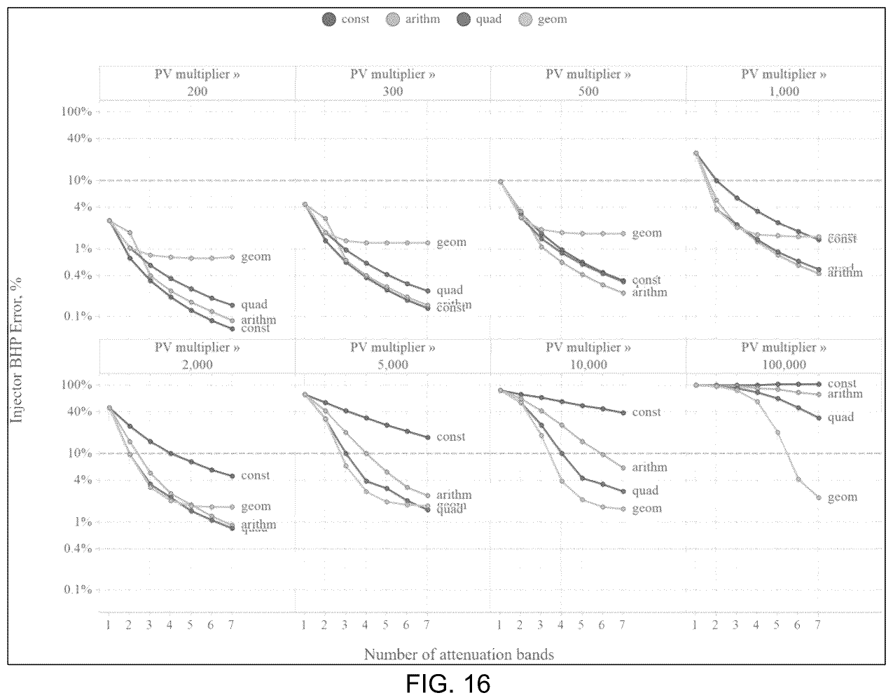

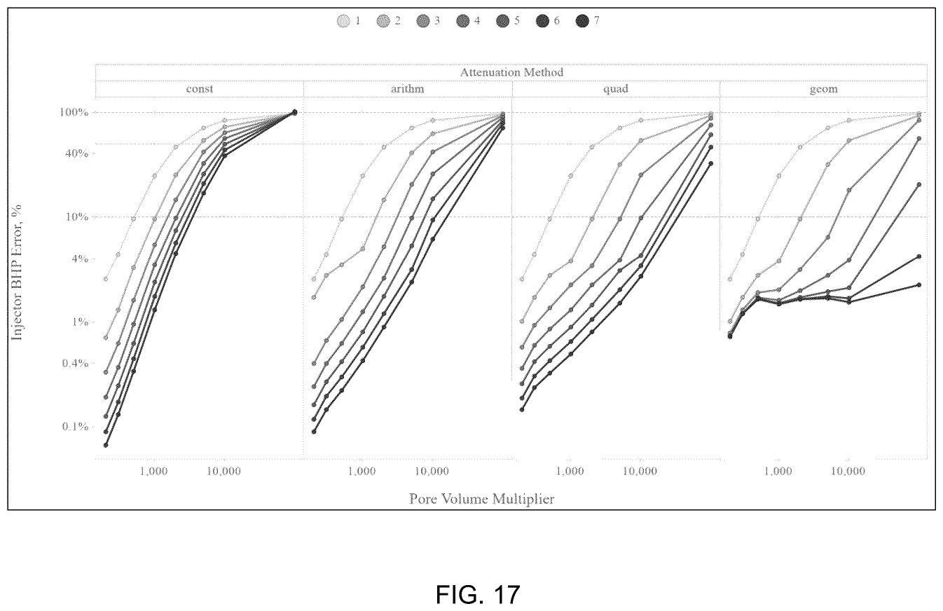

The results of the runs (FIG. 16) show that for cases with lower pore volume multipliers, the error decreases substantially when using gradual arithmetic pore volume inflation and transmissibility attenuation along with more bands to represent the aquifer boundary. For higher pore volume multipliers, quadratic and geometric algorithms reduce the error more effectively, with geometric being the only one that can reach error of <10% for a PVM=100,000. FIG. 17 shows how increasing the number of bands improves the performance of each of the attenuation methods in terms of reducing modelling error, compared to a single band implementation in FIG. 13.

Impact on Pressure Plume and Area of Review (AOR)—Assigning appropriate boundary conditions will have significant impact on pressure front evolution and consequently the Area of Review (AOR) delineation. In most scenarios, the AOR size will be primarily driven by the pressure component. AOR size can have a significant impact on the monitoring costs and actions. Additionally, appropriately modeling pressure propagation and how aquifer systems react to large scale CO₂ injection has relevance to potential geomechanical integrity, fault reactivation, etc.

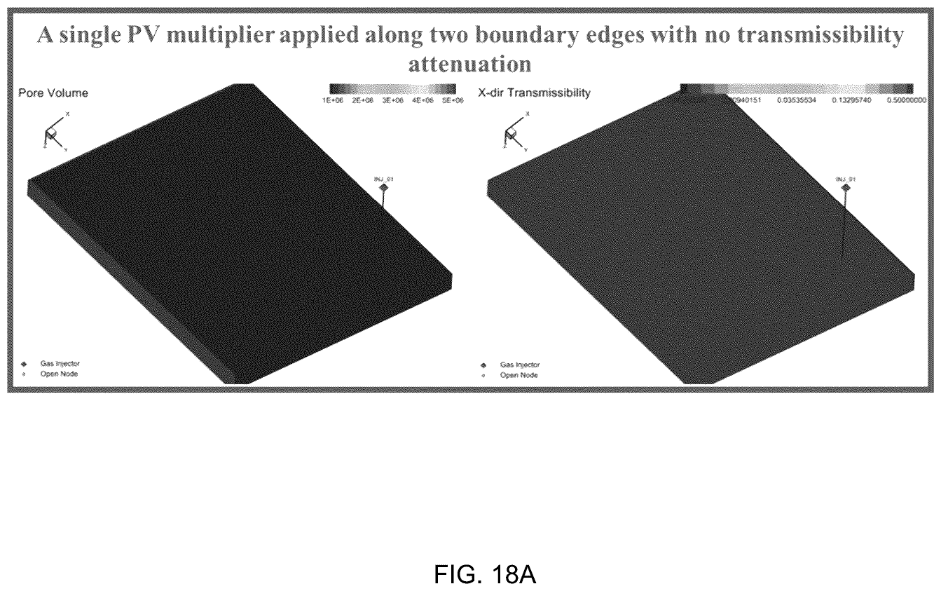

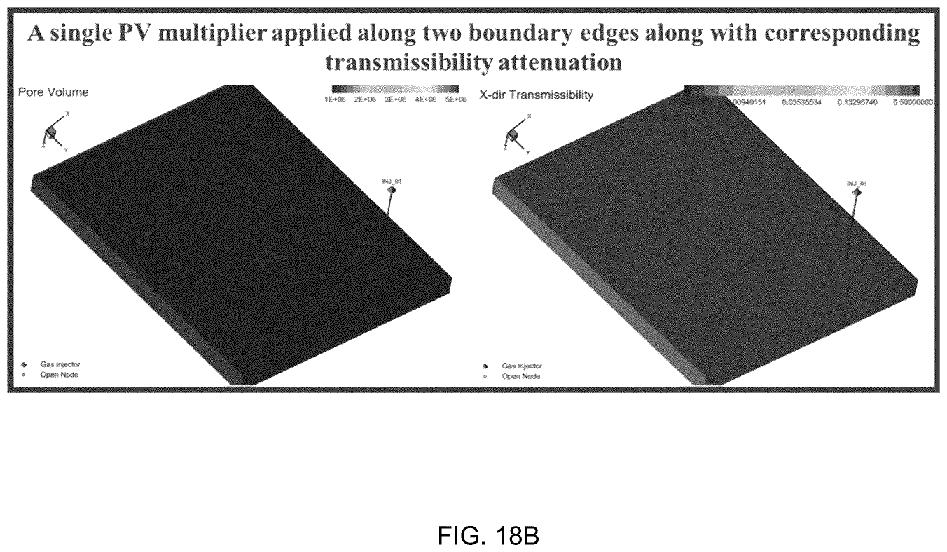

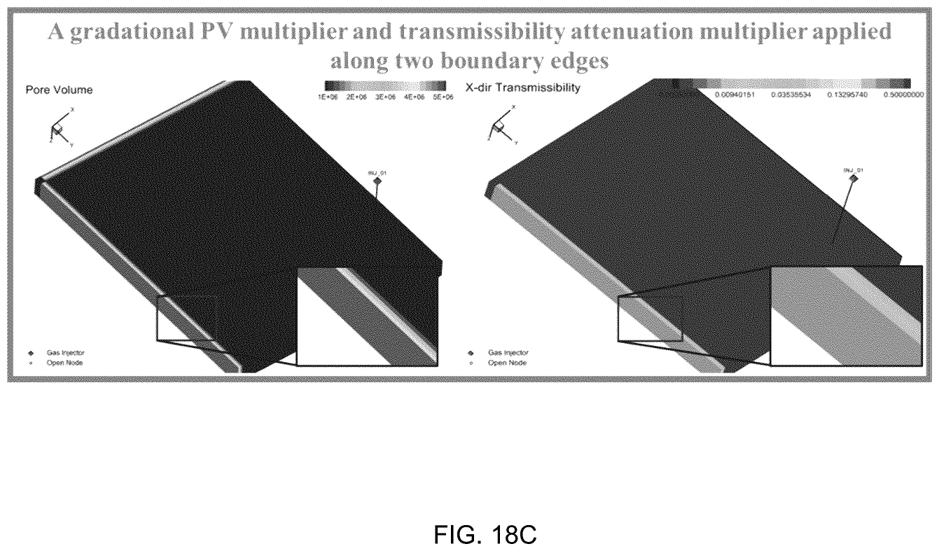

The proposed boundary condition approach from this study was applied to large 3-D models. The results show a significant impact to the pressure diffusion front when compared to more simplified conventional approaches. Assignment of boundary conditions using a variety of approaches were investigated. FIG. 18 shows three boundary condition scenarios in a mechanistic 3-D model: 1) assigning a single PV multiplier, 2) assigning a single PV multiplier and a corresponding single transmissibility attenuation multiplier, and 3) assigning a gradational pore volume multipliers and transmissibility attenuation multipliers over 4 bands of model edge cells. For this exercise, the X and Y boundaries opposite the injector were manipulated. The lateral boundaries nearest the injector were treated as closed, as were the vertical boundaries.

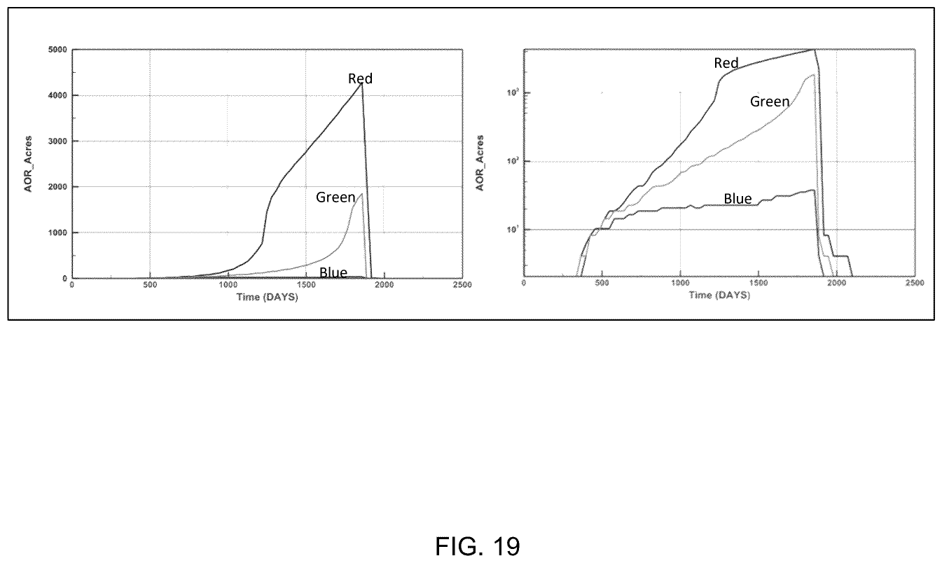

Modeling results from this analysis are shown in FIG. 19 where instantaneous AOR outputs from each case were plotted over the duration of injection for a given critical pressure. This disclosure demonstrates that large PV adjustments without transmissibility reductions overestimates the true aquifer strength, resulting in overall lower pressures and smaller Area of Review. On the other hand, implementing numerical aquifer by using single pore volume multipliers and the associated attenuated transmissibility multipliers will result in more pessimistic pressure response in the reservoir and much larger Area of Review. The results show that this approach of reducing the transmissibility multiplier using a single band starts to choke off the impact of large pore volume. Lastly, the proposed approach of applying gradational pore volume and transmissibility multipliers results in a more realistic pressure propagation prediction and AOR estimation.

Summary and Conclusions-Here are some main highlights of the study discussed herein:
Modeling the pressure response in large regional aquifer systems has significant implications on defining Area of Review as well as relevance to potential geomechanical integrity, fault reactivation, etc.
Assigning the appropriate boundary conditions to replicate the true extent of the aquifer is investigated in this study.
Using large pore volume multipliers only (with no transmissibility attenuation) is generally not an accurate representation of finite subsurface extensions of the formation unless the boundary condition of a constant pressure outer boundary is desired.
Basin-level characterization of aquifer extent and regional geology is the most essential first step in quantifying the total pore volume implement by using pore volume multipliers at the model edge.
Based on the results of this study, it has been found that using a combination of PV and transmissibility multipliers replicates the true solution more accurately.
This disclosure proposes applying a gradual pore volume increase combined with gradual transmissibility reduction as a more accurate representation of the true aquifer system. Proposed approach was validated using mechanistic simulation models.
Modelling error increases as pore volume multipliers grow even when attenuating the transmissibilities. Adding more bands and using a geometric progression of pore volume and transmissibility multipliers can improve modeling error with large aquifers.
Variety of different approaches were investigated in this study to determine the optimum number of boundary cell bands and the methodology to break down the total pore volume over these bands.
In the case of the simple mechanistic model used in the study, it was found that the arithmetic progression of pore volume multipliers through no less than 4 bands is necessary to reduce modeling error to under 10% for pore volume multipliers less than 5,000. For pore volume multipliers of 10,000-100,000, the geometric progression-based attenuation achieved best results, with 6-7 bands always reducing modeling error to under 10%.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method of modifying pore volume and transmissibility in a numerical grid, the method comprising:
a) obtaining a numerical grid for an area of interest (AOI) in a formation, wherein the numerical grid comprises edge bands, wherein the edge bands act as proxies to extensions of the formation, and wherein each extension has a corresponding total pore volume;
b) for each extension, determining an edge band volume for each edge band;
c) for each extension, determining a ratio using the total pore volume and a sum of the determined edge band volumes;
d) for each extension, determining a pore volume to be added to each edge band responsive to the determined ratio;
e) for each extension, determining a pore volume multiplier for each edge band using the determined edge band volume for that edge band and the determined pore volume for that edge band;
f) for each extension, determining a transmissibility multiplier for each edge band using the determined pore volume multiplier for that edge band and the determined pore volume multiplier for an adjacent edge band; and
g) modifying pore volume and transmissibility of each edge band in the numerical grid using the determined pore volume multiplier and the determined transmissibility multiplier.

2. The method of claim 1, wherein determining an edge band volume for each edge band comprises using an equation, and wherein the equation is as follows:
$$EdgeBandVolume i = {\sum }_{j = 1}^{number of edge cells in 1 Edge Band} ( Dxj * Dyj * Dzj * Porosity j )$$
wherein EdgeBandVolume is an edge band volume for an edge band, i is edge band index number, j is edge cell index number, Dx is width, Dy is length, Dz is height, and Porosity is porosity for each edge cell.

3. The method of claim 1, wherein determining a pore volume to be added to each edge band responsive to the determined ratio includes utilizing an arithmetic approach if the ratio is less than or equal to 1000.

4. The method of claim 3, wherein the arithmetic approach includes using an equation to calculate pore volume (PV) to be added to each edge band, and the equation is as follows:
$$P {V}_{i} = i * \frac{2 ( T P V )}{{N}_{bands} * ( {N}_{bands} + 1 )}$$
where i is edge band index number, N_{bands} is total number of edge bands, and TPV is Total Pore Volume.

5. The method of claim 1, wherein determining a pore volume to be added to each edge band responsive to the determined ratio includes utilizing a geometric approach if the ratio is more than 1000.

6. The method of claim 5, wherein the geometric approach includes using an equation to calculate pore volume (PV) to be added for each edge band, and the equation is as follows:
$$P Vi = \frac{( {r}^{i} )}{{S}_{{N}_{bands}}} * ( T P V )$$
where i is edge band index number, r is root of 3, TPV is Total Pore Volume and S_{Nbands} is calculated as S_{Nbands}=Σⱼ₌₁^{N}^{_{bands}}r^{j} where N_{bands} is total number of edge bands, r is root of 3.

7. The method of claim 1, wherein determining a pore volume multiplier for each edge band using the determined edge band volume for that edge band and the determined pore volume for that edge band includes using an equation, and wherein the equation is as follows:
$$P V {M}_{i} = \frac{P {V}_{i} + {EdgeBandVolume}_{i}}{{EdgeBandVolume}_{i}}$$
where i is edge band index number, PV is pore volume to be added, EdgeBandVolume is edge band volume, and PVM is pore volume multiplier.

8. The method of claim 1, wherein determining a transmissibility multiplier for each edge band using the determined pore volume multiplier for that edge band and the determined pore volume multiplier for an adjacent edge band includes using an equation, and wherein the equation is as follows if the extension is located to the last grid block index (Nx) of Nx grid blocks:
$$T {M}_{i} = \frac{2}{( P V {M}_{i} + P V {M}_{i + 1} )} starting at block Nx - N bands$$
where i is edge band index number, PVM is pore volume multiplier, and TM is transmissibility.

9. The method of claim 1, wherein determining transmissibility attenuation for each edge band using the determined pore volume multiplier for that edge band and the determined pore volume multiplier for an adjacent edge band includes using an equation, and wherein the equation is as follows if the extension is located to the first grid block index (1) of Nx grid blocks:
$$T {M}_{i} = \frac{2}{( P V {M}_{i} + P V {M}_{i - 1} )} starting at block 1 for N band$$
where i is edge band index number, PVM is pore volume multiplier, and TM is transmissibility.

10. The method of claim 1, wherein four edge bands act as a proxy for a single extension.

11. A computer system, comprising:
one or more processors;
memory; and
one or more programs, wherein the one or more programs are stored in the memory and configured to be executed by the one or more processors, the one or more programs including instructions that when executed by the one or more processors cause the computer system to perform a method of modifying pore volume and transmissibility in a numerical grid, the method comprising:
a) obtaining a numerical grid for an area of interest (AOI) in a formation, wherein the numerical grid comprises edge bands, wherein the edge bands act as proxies to extensions of the formation, and wherein each extension has a corresponding total pore volume;
b) for each extension, determining an edge band volume for each edge band;
c) for each extension, determining a ratio using the total pore volume and a sum of the determined edge band volumes;
d) for each extension, determining a pore volume to be added to each edge band responsive to the determined ratio;
e) for each extension, determining a pore volume multiplier for each edge band using the determined edge band volume for that edge band and the determined pore volume for that edge band;
f) for each extension, determining a transmissibility multiplier for each edge band using the determined pore volume multiplier for that edge band and the determined pore volume multiplier for an adjacent edge band; and
g) modifying pore volume and transmissibility of each edge band in the numerical grid using the determined pore volume multiplier and the determined transmissibility multiplier.

12. The system of claim 11, wherein determining an edge band volume for each edge band comprises using an equation, and wherein the equation is as follows:
$$EdgeBandVolume i = {\sum }_{j = 1}^{number of edge cells in 1 Edge Band} ( Dxj * Dyj * Dzj * Porosity j$$
wherein EdgeBandVolume is an edge band volume for an edge band, i is edge band index number, j is edge cell index number, Dx is width, Dy is length, Dz is height, and Porosity is porosity for each edge cell.

13. The system of claim 11, wherein determining a pore volume to be added to each edge band responsive to the determined ratio includes utilizing an arithmetic approach if the ratio is less than or equal to 1000.

14. The system of claim 13, wherein the arithmetic approach includes using an equation to calculate pore volume (PV) to be added to each edge band, and the equation is as follows:
$$P {V}_{i} = i * \frac{2 ( T P V )}{{N}_{bands} * ( {N}_{bands} + 1 )}$$
where i is edge band index number, N_{bands} is total number of edge bands, and TPV is Total Pore Volume.

15. The system of claim 11, wherein determining a pore volume to be added to each edge band responsive to the determined ratio includes utilizing a geometric approach if the ratio is more than 1000.

16. The system of claim 15, wherein the geometric approach includes using an equation to calculate pore volume (PV) to be added for each edge band, and the equation is as follows:
$$P Vi = \frac{( {r}^{i} )}{{S}_{{N}_{bands}}} * ( T P V )$$
where i is edge band index number, r is root of 3, TPV is Total Pore Volume and S_{Nbands} IS calculated as S_{N}_{_{bands}}=Σⱼ₌₁^{N}^{_{bands}}r^{j} where N_{bands} is total number of edge bands, r is root of 3.

17. The system of claim 11, wherein determining a pore volume multiplier for each edge band using the determined edge band volume for that edge band and the determined pore volume for that edge band includes using an equation, and wherein the equation is as follows:
$$P V {M}_{i} = \frac{P {V}_{i} + {EdgeBandVolume}_{i}}{{EdgeBandVolume}_{i}}$$
where i is edge band index number, PV is pore volume to be added, EdgeBandVolume is edge band volume, and PVM is pore volume multiplier.

18. The system of claim 11, wherein determining a transmissibility multiplier for each edge band using the determined pore volume multiplier for that edge band and the determined pore volume multiplier for an adjacent edge band includes using an equation, and wherein the equation is as follows if the extension is located to the last grid block index (Nx) of Nx grid blocks:
$$T {M}_{i} = \frac{2}{( P V {M}_{i} + P V {M}_{i + 1} )} starting at block Nx - N bands$$
where i is edge band index number, PVM is pore volume multiplier, and TM is transmissibility.

19. The system of claim 11, wherein determining transmissibility attenuation for each edge band using the determined pore volume multiplier for that edge band and the determined pore volume multiplier for an adjacent edge band includes using an equation, and wherein the equation is as follows if the extension is located to the first grid block index (1) of Nx grid blocks:
$$T {M}_{i} = \frac{2}{( P V {M}_{i} + P V {M}_{i - 1} )} starting at block 1 for N band$$
where i is edge band index number, PVM is pore volume multiplier, and TM is transmissibility.

20. A non-transitory computer readable storage medium storing one or more programs, the one or more programs comprising instructions, which when executed by an electronic device with one or more processors and memory, cause the device to perform a method of modifying pore volume and transmissibility in a numerical grid, the method comprising:
a) obtaining a numerical grid for an area of interest (AOI) in a formation, wherein the numerical grid comprises edge bands, wherein the edge bands act as proxies to extensions of the formation, and wherein each extension has a corresponding total pore volume;
b) for each extension, determining an edge band volume for each edge band;
c) for each extension, determining a ratio using the total pore volume and a sum of the determined edge band volumes;
d) for each extension, determining a pore volume to be added to each edge band responsive to the determined ratio;
e) for each extension, determining a pore volume multiplier for each edge band using the determined edge band volume for that edge band and the determined pore volume for that edge band;
f) for each extension, determining a transmissibility multiplier for each edge band using the determined pore volume multiplier for that edge band and the determined pore volume multiplier for an adjacent edge band; and
g) modifying pore volume and transmissibility of each edge band in the numerical grid using the determined pore volume multiplier and the determined transmissibility multiplier.
